(19) United States
(12) Patent Application Publication
(10) Pub. No.: US 2022/0063806 A1
(43) Pub. Date: Mar. 3, 2022

(54) LIQUID PROPELLED UNMANNED AERIAL VEHICLE

(71) Applicant: Pasha Holding B.V., Delfgauw (NL)

(72) Inventors: Adnan Tunovic, Delfgauw (NL); Franciscus Petrus Maria van Hoeij, Berkel En Rodenrijs (NL)

(21) Appl. No.: 17/421,063

(22) PCT Filed: Jan. 7, 2020
(86) PCT No.: PCT/NL2020/050008

§ 371 Date: Jul. 7, 2021

(30) Foreign Application Priority Data
Jan. 11, 2019 (NL) 2022378

(51) Int. Cl. B64D 1/18; B64C 15/02; B64C 17/04; B64C 17/08; B64C 39/02

(52) U.S. Cl. CPC B64D 1/18; B64C 15/02; B64C 17/04; B64C 17/08; B64C 2201/16; B64C 39/024; B64C 2201/027; B64C 2201/04; B64C 2201/12; B64C 39/022

(57) ABSTRACT

A liquid propelled unmanned aerial vehicle includes a carrier and a nozzle assembly mounted to the carrier. The nozzle assembly includes a nozzle adapted to eject a liquid propulsion jet, and a liquid inlet connection in fluid communication with the nozzle to connect the nozzle assembly to a pressurized liquid source. The nozzle has a variable orientation relative to the carrier. A control unit is operationally connected to the moveable nozzle so as to control the orientation of the nozzle and thereby the direction of the propulsion jet. A stabilising weight is suspended from the carrier and arranged such that a centre of gravity of the aerial vehicle is located in use below the nozzle.

### CROSS-REFERENCE TO RELATED APPLICATIONS

This application is the National Stage of International Application No. PCT/NL2020/050008, filed Jan. 7, 2020, which claims the benefit of Netherlands Application No. 2022378, filed Jan. 11, 2019, the contents of which is incorporated by reference herein.

### FIELD OF THE INVENTION

The invention relates to a water propelled aerial vehicle.

### BACKGROUND OF THE INVENTION

Water propelled aerial vehicles are known, for example for recreational purposes. An example of such an aerial vehicle is shown in U.S. Pat. No. 8,336,805. This known vehicle includes a platform on which person can stand. The platform is provided with a pair of main propulsion nozzles, which are attached to the platform with no degree of freedom. Furthermore there are two secondary nozzles which are for being held by the forearms or the hands of the person. The person has the task of positioning and directing the secondary nozzles with his or her hands and arms and the main nozzles by playing with the inclination of the platform, e.g. using his feet, legs, pelvis or torso, in order to pilot the propulsion of the vehicle.

### SUMMARY OF THE INVENTION

The present invention relates in particular to an unmanned liquid propelled vehicle comprising:
a carrier,
a nozzle assembly mounted to the carrier, the nozzle assembly comprising at least one nozzle adapted to eject a liquid, e.g. water, propulsion jet, and a liquid inlet connection in fluid communication with the nozzle to connect the nozzle assembly to a pressurized liquid source, wherein the nozzle has a variable orientation relative to the carrier,
a control unit operationally connected to the moveable nozzle so as to control the orientation of the nozzle and thereby the direction of the propulsion and treatment jet,
a stabilising weight suspended from the carrier and arranged such that a centre of gravity of the device is located in use below the nozzle.

The unmanned aerial vehicle can be manoeuvred by changing the orientation of the nozzle, whereby the direction of the propulsion jet is changed. The stabilising weight assures that the vehicle remains stably in a more or less upright position. It mitigates the effect of external forces, e.g. by wind or draught, to which the vehicle is subjected during use.

Such an unmanned vehicle can have several purposes, but the invention is in particular intended for firefighting purposes. According to one aspect the invention thus relates to a fire-fighting device comprising an unmanned aerial vehicle as described in the above, and furthermore comprising a water hose connected to the liquid inlet connection of the nozzle assembly, wherein the nozzle is adapted to direct the water jet to the fire.

The aerial vehicle according to the invention can be controlled by an operator or by an automatic controller. It can be directed towards a fire into areas which are dangerous or difficult to access by fire-fighting personnel.

In a possible embodiment of the unmanned aerial vehicle according to the invention, the stabilising weight is associated with actively controllable positioning means for varying the position of the stabilising weight relative to the carrier. Thus, actively varying the position of the stabilising weight provides a possibility to manoeuvre the vehicle other than by the propulsion jet, for example when the jet is directed to be maintained on a fire and the position of the vehicle is to be adapted.

In a further possible embodiment of the unmanned vehicle according to the invention, the carrier comprises a weight mounting system for mounting the stabilising weight to the carrier in a suspended manner, the weight mounting system comprising at least three mounting points, preferably arranged in a triangular or rectangular configuration, from which mounting points the stabilising weight is suspended from the carrier.

In a further possible embodiment of the unmanned vehicle according to the invention, the vehicle comprises at least three elongate arms extending outwardly from a main body of the carrier, and wherein the at least three mounting points are respectively arranged on the respective arms. The arms increase the inertia of the vehicle and have a positive effect on the mitigation of disturbances, e.g. by wind or draught.

In a further possible embodiment of the unmanned vehicle according to the invention, the stabilising weight is suspended from the body with non-rigid suspension elements, i.e. elements that allow to be tensioned but not to be compressed, e.g. a chain, a wire or a rope.

In a further possible embodiment of the unmanned vehicle according to the invention, the stabilising weight has an inlet and/or an outlet to allow ballast, e.g. a fluid, to be introduced into the stabilising weight and/or to be expelled from the stabilising weight, to vary the mass of said stabilising weight.

In a further possible embodiment of the unmanned vehicle according to the invention, the device further comprises a fluid channel that provides a fluid communication between the liquid inlet of the nozzle assembly and the inlet of the stabilising weight.

In a possible embodiment of the unmanned aerial vehicle according to the invention the device furthermore comprises a sensor array which is mounted to the carrier. The sensor array may contain several sensors to detect different parameters and signals. For example a sensor for control signals may be present. Also a sensor for detection the roll and pitch orientation of the aerial vehicle may be detected, which may be used in (feedback) control system to control and stabilize the aerial vehicle.

In a possible embodiment of the fire-fighting device according to the invention, the unmanned aerial vehicle comprises a heat resistant shielding, wherein at least the carrier and the fluid inlet connection of the nozzle assembly are enclosed by the heat-resistant shielding to protect them against external heat caused by a fire.

In a further embodiment of the fire-fighting device the heat-resistant shielding includes cooling channels through which cooling fluid flows to cool the shielding. In a possible further embodiment the cooling channels are in fluid communication with the water inlet connection of the nozzle assembly to allow water from the water source to flow through the cooling channels.

In a further embodiment a stabilizing wire is connected to and arranged between the hose and the carrier of the unmanned aerial vehicle.

### BRIEF DESCRIPTION OF THE DRAWINGS

The invention will be further elaborated in the following detailed description with reference to the drawings, in which:

FIG. 1 shows a side view in perspective of an embodiment of a water propelled unmanned aerial vehicle according to the invention in use,

FIG. 2 shows a more detailed view in perspective from above of the aerial vehicle of FIG. 1,

FIG. 3 shows another view in perspective of the aerial vehicle of FIG. 1,

FIG. 4 shows another view in perspective of the aerial vehicle of FIG. 1, and

FIG. 5 shows a view in perspective of the aerial vehicle of FIG. 1 provided with a shielding.

### DETAILED DESCRIPTION OF THE INVENTION

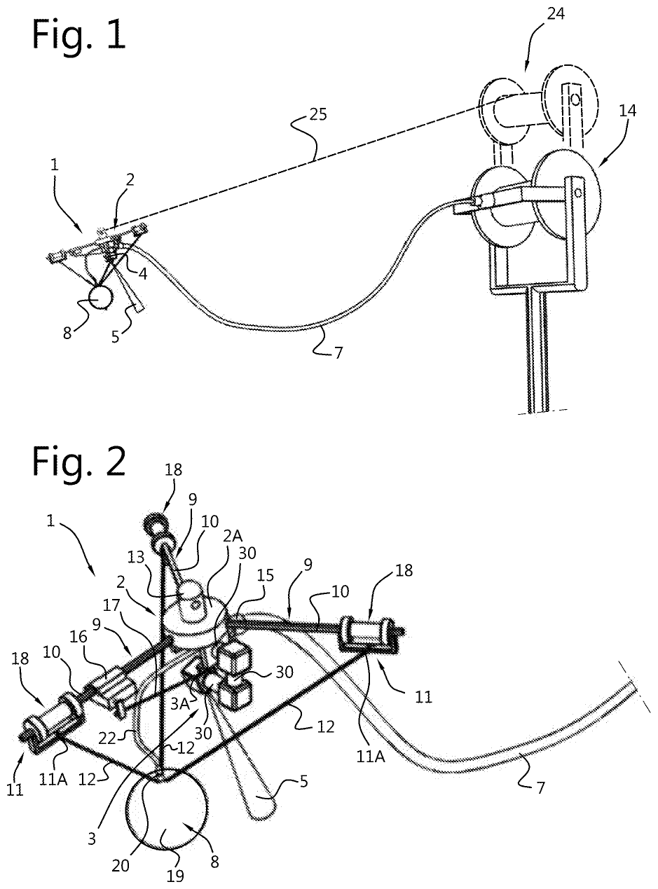

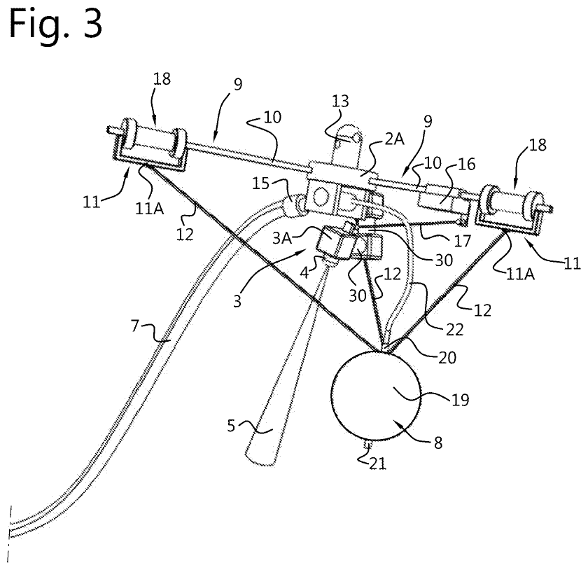

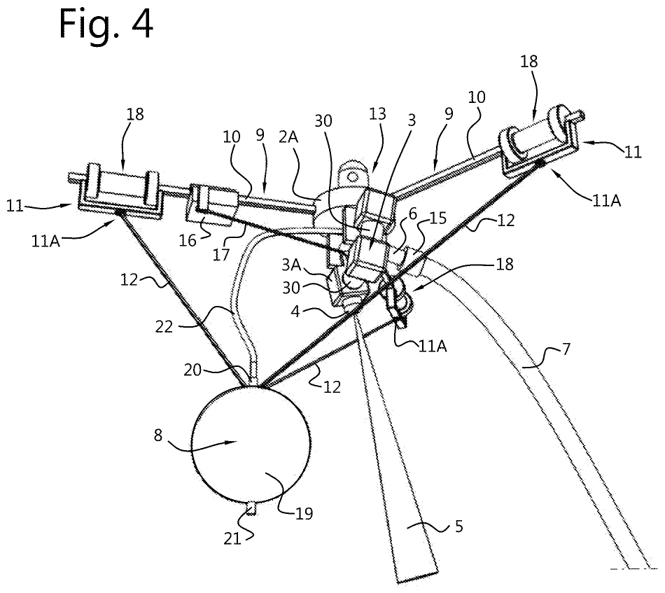

The FIGS. 1-4 show an unmanned aerial vehicle which may be used for different purposes. In this detailed description it will be described in the light of a fire-fighting purpose, but it is noted that also other purposes are conceivable, such as cleaning, painting, spraying or other surface treatment purposes.

The FIGS. 1-4 show a water propelled unmanned aerial vehicle 1 which is designed for extinguishing a fire from an aerial position above the ground 100. The aerial vehicle 1 comprises a carrier 2, which forms the main body of the vehicle. A nozzle assembly 3 is mounted to the carrier.

The nozzle assembly 3 comprises a nozzle 4 adapted to eject a water propulsion jet 5. The nozzle assembly 3 furthermore comprises a water inlet connection 6, which is in fluid communication with the nozzle 4 to connect the nozzle assembly 3 to a pressurized water source. In the figures is shown how a water hose 7 is connected to the water inlet connection 6. The water hose 7 supplies water to the aerial vehicle 1 from a pressurized water source. The water pressure in the hose is for this specific application in practise preferably within the range of 90-160 bar.

The nozzle assembly 3 has preferably a configuration of tubes 30 which provides that the water jet has partly an opposite direction than the end of the hose 7 at the location of the coupling 15 with the water inlet connection 6 of the nozzle assembly 3. The provides the effect that the impact force of the high pressure water flow on the nozzle assembly 3 at the water inlet connection 6 is at least partly compensated by the force generated by the ejected propulsion jet 5. This provides a better stability of the aerial vehicle during operation.

The nozzle 4 is moveable and has a variable orientation relative to the carrier 2. Thereby the direction of the propulsion jet 5 can be changed, and thus the direction of movement can be changed. The propulsion jet 5 is used to steer and move the vehicle, and also to maintain it hovering in position.

In a possible embodiment, which is shown in the figures, the pitch of the aerial vehicle 1 is controlled by the direction of the propulsion jet 5, thus by controlling the orientation of the nozzle 4. To this end the aerial vehicle 1 comprises an actuator 16 which is connected by means of a control rod 17 to a rotatable part 3A of the nozzle assembly 3, including the nozzle 4. By pulling or pushing the control rod 17, the orientation of the nozzle can be changed and the pitch of the vehicle 1 can be controlled.

The roll of the aerial vehicle 1 may be conveniently controlled by an actuator which is incorporated in or at the coupling 15 of the hose 7 and the water inlet connection 6. This incorporated actuator may comprise an electromagnetic actuator, by which a coupling part connected to the inlet connection 6 and the coupling part connected to the hose 7 can be rotated relative to each other. Since the hose 7 will generally be a relatively rigid part in the rotation direction, the roll of the vehicle 1 can be controlled with respect to this hose 7 without too much disturbances caused by deformation of the hose 7.

The nozzle 4 is controlled by a control unit operationally connected to the moveable nozzle 4, in the example with the actuator 16 so as to control the orientation of the nozzle 4 and thereby the direction of the propulsion jet 5. The control unit is also operationally connected with the actuator in the coupling 6 for the roll movement.

The control unit may include a remote control by which the flight of the aerial vehicle may be remotely controlled by a human operator or a computer.

In the embodiment shown in the figures a sensor array 13 is mounted on top of the main body 2A of the carrier 2. This sensor array 13 may comprise different sensors to detect different parameters such as control signals, position and orientation of the carrier, temperature etc.

The nozzle 4 and its control means are configured to simultaneously:

1) exhaust a fluid stream received from said fluid source in a substantially downwards direction with a pressure of at least 50 bars, thereby thrusting the unmanned aerial vehicle into the air or hovering the unmanned aerial vehicle in the air, and
2) extinguish a fire by directing said fluid towards the fire.

Although this is not shown in the figures it is conceivable for firefighting purposes to have a first nozzle which is only used for propulsion of the aerial vehicle, and a second nozzle which is use for ejecting a fire extinguishing spray or jet, which may contain water and/or fire extinguishing agents. The expulsion force of the second nozzle may be considerably lower than the expulsion force at the first nozzle.

In the example shown in the figures, the nozzle assembly comprises one nozzle 4. However, it is also conceivable that the nozzle assembly has multiple nozzles for propulsion purposes, which may be controlled separately.

In order to maintain the vehicle in flight in a stable position a stabilising weight 8 is suspended from the carrier and arranged such that a centre of gravity of the device is located in use below the nozzle 4. The inertia of the stabilising weight 8 in operation of the unmanned aerial vehicle 1 counteracts external dispositioning forces acting on the unmanned aerial vehicle 1, thereby self-stabilizing the unmanned aerial vehicle 1. Possible external dispositioning forces may be wind or draught within a building.

The unmanned aerial vehicle 1 comprises at least three arms 9, which may be tubular or massive rods 10 that extend outwards with respect to a main body 2A of the carrier 2. The rods 10 are arranged having a mutual angle between the respective rods 10 between 80° and 150°. The rods 10 define an imaginary plane.

The stabilising weight 8 is suspended from the arms 9, in particular the rods 10. Thereto the arms 9 comprise three respective weight mounting elements 11 positioned on the rods 10. The position of the weight mounting elements 11 is adjustable. The weight 8 is suspended from the weight mounting elements 11 by three flexible tensionable elements 12.

In the specific embodiment shown in the figures the flexible tensionable elements 12 are constituted by cables, but also other elements which can resist tensional forces (i.e. axial pulling forces) but cannot withstand pressure forces such as wires, cables, ropes, chains etc. may be contemplated. The three mounting points 11A are arranged in a triangular configuration in the mentioned imaginary plane defined by the rods 10.

The unmanned aerial vehicle may comprise one or more dedicated actuators 18 configured and arranged to actively displace at least one of the mounting elements 11 with respect to the corresponding rod 10, thereby changing the position of the stabilising weight 8 with respect to the carrier 2 and steering the unmanned aerial vehicle 1 through the air. A displacement of the mounting elements 11 is along the arms 9 in the longitudinal direction thereof.

It would be also conceivable to have structure, e.g. with telescopic rods in which a part of the rods is moveable to move the mounting elements 11. Also other, generally more complex structures are conceivable, wherein rods can be displace in an angular fashion, e.g. by pivots.

The displacement of the rods 11 may be an angular or a longitudinal displacement driven by suitable other actuator(s) not shown here.

The stabilising weight 8 may comprises a fluid contained in a container 19. The stabilising weight 8 has an inlet 20 and/or an outlet 21 to allow ballast e.g. a fluid to be introduced into the container containing the weight 8 and/or to be expelled from the container 19 containing the weight, to vary the mass of the weight 8. The inlet and the outlet may be defined by the same opening, but are in the example shown in the figures separate.

A secondary fluid channel 22 is provided that provides a fluid communication between the fluid inlet connection 6 of the nozzle assembly 3 and the inlet 20 of the weight 8.

In a fire-fighting application the unmanned aerial vehicle may comprise a heat resistant shielding, wherein at least the carrier 2 and the fluid inlet connection 6 of the nozzle assembly 3 are enclosed by the heat-resistant shielding to protect them against external heat caused by a fire. The heat-resistant shielding may include cooling channels through which cooling fluid flows to cool the shielding. The cooling channels may be in fluid communication with the water inlet connection 6 of the nozzle assembly 3 to allow water from the water source to flow through the cooling channels.

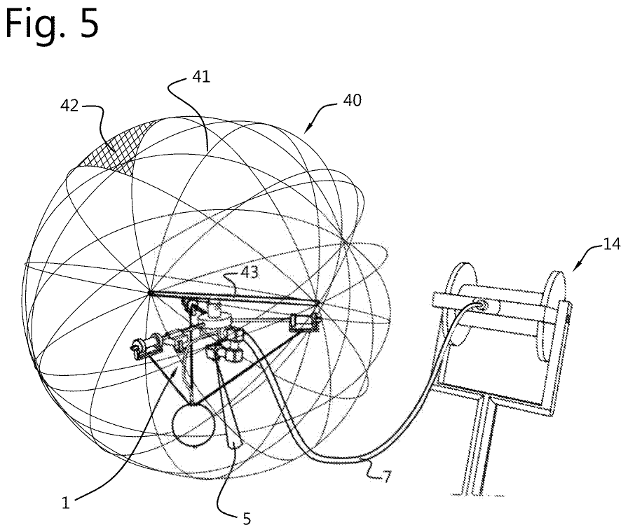

In FIG. 5 is shown an example of a shielding 40 wherein cooling tubes 41 are arranged and configured to form a ball configuration. A wire mesh, as indicated at 42, may be arranged over the ball of cooling tubes 41. The wire mesh may have an opening for the propulsion jet 5. The shielding 40 comprises an attachment member 43 to attach the shielding 40 to the aerial vehicle 1.

During a fire-fighting operation the unmanned vehicle can be manoeuvred to a location where there is a fire. This may be in the open filed, but it may also be within a building where it is too dangerous for firemen to enter in a conventional way. The aerial vehicle 1 may move autonomous, i.e. controlled by an automatic control system based on data of the surroundings and the location of the fire. The vehicle may also be controlled manually by a human operator. Also a hybrid of manual and automatic control may be used to manoeuvre the aerial vehicle 1 and extinguish the fire.

The aerial vehicle 1 drags the hose 7 along, whereby the hose 7 thus floats in the air at least partially. The hose may be stored on a reel 14 which unwinds when the aerial vehicle 1 pulls it. It is also possible to actively control the movement of the reel 14, which control may be coupled with the control of the aerial vehicle 1. Thus the reel 14 may actively unwind or rewind the hose 7 depending on the control signal sent to the aerial vehicle 1.

A stabilizing wire is connected to and arranged between the hose 7 and the carrier 2 of the unmanned aerial vehicle 1. Or, as is indicated by a dashed line in FIG. 1, a stabilizing wire 25 may be connected to a reel 24 arranged near, preferably above the reel 14 for the hose 7 and to the vehicle 1 or a location on the hose 7 near the vehicle 1. The stabilizing wire 24 keeps the vehicle stable in the air even when the vehicle 1 operates with high pressures.

In the event that the hose 7 has to be carried over a greater length, it is conceivable to connect more than one aerial vehicles 1 as described in a series connection. Thus a first hose 7 is connected to the water source and to the first aerial vehicle 1. This first aerial vehicle has an additional outlet connection for another hose 7. A second hose 7 is connected to this additional outlet connection of the first aerial vehicle 1 and to the inlet connection 6 of the second aerial vehicle 1. Thus a series connection of hoses 7 and aerial vehicles 1 can be made to span a larger distance e.g. for firefighting situations wherein one long hose 7 is too heavy to be carried by one aerial vehicle 1.

It is noted that although in the figures it appears that the hose 7 is hanging fully in the air, it may in some situations very well acceptable to have a part of the hose 7 resting on the floor. This reduces the weight that an aerial vehicle in the system has to carry. Furthermore it improves the stability of the aerial vehicle due to the shorter unsupported length of the high pressure hose 7.

For fire-fighting applications water will be used for propulsion of the aerial vehicle. It must be understood though that the water may contain additive substances which enhance the fire extinguishing properties. In general it is noted that although the invention is explained with the use of water as a practical liquid for use in fire-fighting applications, the term “water” may also be replaced by “liquid” in general, e.g. for other applications.

The aerial vehicle may also be used for surface treatment e.g. cleaning of a surface, wherein the fluid is e.g. comprises water, possibly mixed with a cleaning solution. One may for example think of cleaning outside cladding and window panels of high rise buildings. Another possible exemplary application may be spraying pesticides, insecticides or other substances in agricultural environments. Also the use of the aerial vehicle for painting a surface, wherein the fluid contains e.g. sprayable paint is conceivable.

1. A liquid propelled unmanned aerial vehicle comprising:
a carrier,
a nozzle assembly mounted to the carrier, the nozzle assembly comprising at least one nozzle adapted to eject a liquid propulsion jet, and a liquid inlet connection in fluid communication with the nozzle to connect the nozzle assembly to a pressurized liquid source, wherein the nozzle has a variable orientation relative to the carrier,
a control unit operationally connected to the moveable nozzle so as to control the orientation of the nozzle and thereby the direction of the propulsion jet, and
a stabilising weight suspended from the carrier and arranged such that a centre of gravity of the vehicle is located in use below the nozzle.

2. The unmanned aerial vehicle according to claim 1, wherein the stabilising weight is associated with actively controllable positioning means for varying the position of the stabilising weight relative to the carrier.

3. The unmanned aerial vehicle according to claim 1, wherein the carrier comprises a weight mounting system for mounting the stabilising weight to the carrier in a suspended manner, the weight mounting system comprising at least three mounting points, preferably arranged in a triangular or rectangular configuration, from which mounting points the stabilising weight is suspended from the carrier.

4. The unmanned aerial vehicle according to claim 1, wherein the vehicle comprises at least three elongate arms extending outwardly from a main body of the carrier, and wherein the at least three mounting points are respectively arranged on the respective arms.

5. The unmanned aerial vehicle according to claim 1, wherein the stabilising weight is suspended from the carrier with non-rigid suspension elements, i.e. elements that allow to be tensioned but not to be compressed, e.g. a chain, a wire or a rope.

6. The unmanned aerial vehicle according to claim 1, wherein the stabilising weight has an inlet and/or an outlet to allow ballast, e.g. a fluid, to be introduced into the stabilising weight and/or to be expelled from the stabilising weight, to vary the mass of said stabilising weight.

7. The unmanned aerial vehicle according to claim 1, wherein the device further comprises a liquid channel that provides a fluid communication between the liquid inlet of the nozzle assembly and the inlet of the stabilising weight.

8. The unmanned aerial vehicle according to claim 1, wherein the device furthermore comprises a sensor array which is mounted to the carrier.

9. A fire-fighting Fire fighting device comprising an unmanned aerial vehicle according to claim 1, and furthermore comprising a liquid hose connected to the liquid inlet connection of the nozzle assembly, wherein the nozzle of the nozzle assembly is adapted to direct the liquid jet to the fire.

10. The fire-fighting device according to claim 9, wherein the unmanned aerial vehicle comprises a heat resistant shielding, wherein at least the carrier and the liquid inlet connection of the nozzle assembly are enclosed by the heat-resistant shielding to protect them against external heat caused by a fire.

11. The fire-fighting device according to claim 10, wherein the heat-resistant shielding includes cooling channels through which cooling fluid flows to cool the shielding.

12. The fire-fighting device according to claim 11, wherein the cooling channels are in fluid communication with the liquid inlet connection of the nozzle assembly to allow liquid from the liquid source to flow through the cooling channels.

13. The fire-fighting device according to claim 9, wherein a stabilizing wire is connected to and arranged between the hose and the carrier of the unmanned aerial vehicle.

14. A method for extinguishing a fire comprising:
providing the fire-fighting device according to claim 9,
directing the unmanned aerial vehicle towards the fire location and
directing the nozzle to the fire to extinguish the fire with the jet.
